(19) United States
(12) Patent Application Publication
(10) Pub. No.: US 2004/0150242 A1
(43) Pub. Date: Aug. 5, 2004

(54) Method for the production of a structural component

(76) Inventors: Franz Heilmeier, Aham (DE); Josef Bachner, Moosthenning (DE); Klaus Sammer, Malgersdorf (DE); Udo Haenle, Guending (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/717,961

(22) Filed: Nov. 21, 2003

Related U.S. Application Data
(63) Continuation of application No. PCT/EP02/05617, filed on May 22, 2002.

(30) Foreign Application Priority Data
May 23, 2001 (DE) 101 25 065.7

(51) Int. Cl. B62D 27/00

(52) U.S. Cl. 296/29

(57) ABSTRACT

In order to enhance solidity and rigidity of structural components of at least two partial shells, flanges of the partial shells are connected to one another by conducting a flanging process while inserting a resistant adhesive. The inventive method is particularly suitable for long support components such as engine mountings.

This is a continuation of International Application PCT/EP02/05617, with an international filing date of May 22, 2002, the entire disclosure of which is incorporated herein by reference.

This application also claims the priority of prior German application 101 25 065.7, filed May 23, 2001.

### BACKGROUND AND SUMMARY OF THE INVENTION

The present invention relates to a method for producing a structural component such as an elongated support component for a motor vehicle.

Structural components, such as motor supports, are ordinarily combined from two shell sections of sheet metal material along their flanges by means of spot welding or riveting. In this way, elongated, hollow components with closed cross-sections arise. With the punctiform methods of attachment mentioned, the weld spots of the rivets can tear out in the event of a crash that exerts high peeling tension stress.

In contrast to the production of closed, one-piece structural components by means of an internal high pressure reshaping process (IHU), there exists with the shell construction method the possibility of inserting internal fittings, such as partitions or linings, into the interior of the structural component. Also, in contrast to the IHU process, it is possible in the shell construction method to attach a flange to the end of the structural component in a simple manner for attaching it to the body of the vehicle. For the reasons stated above, a need exists to optimize the shell construction method for structural components that generally are shaped in a complicated manner and provided with various internal fittings.

One object of the invention is to provide a method by which structural components that are subjected to high mechanical stresses can be produced in a cost-effective and rapid manner.

This object is attained, in a method for producing a structural component for a motor vehicle, including shell sections attached to one another along flanges, by attaching the shell sections of the structural component to one another by flanging.

A basic idea is to connect the shell sections of the structural component to one another along their flanges by means of flanging. In this way, a linear connection along the flanges arises, which in contrast to spot welding or rivet connections gives support over the entire length of the structural component. In this manner, a substantial improvement over the above-named method of attachment is attained, as with spot welding or riveting, only a small portion of the flange is used in the attachment. Especially under the stress caused by peeling tension, a tearing out of the punctiform points of connection can occur and therewith a separation of the structural component. With the method in accordance with the invention, however, the rigidity and strength of structural components is increased with respect to stresses perpendicular to the plane of the flange.

In particular, with the linear flanged joint, the structural component is prevented from tearing out in the event of a crash, and a selective folding of the closed hollow profile of the structural component is achieved, with a corresponding high absorption of energy. The flanging method of the invention is especially well suited for use with elongated structural components, such as engine supports or rear longitudinal supports. With supports of this type, the continuous flanged joint along the elongated areas of attachment produces a particularly positive effect.

In comparison with the riveting method, with flanging, it is possible to make the flange on the two shell sections narrower, thus saving on material and weight overall.

The amount of time required to produce a flanged joint is considerably less than the amount of time required to set a large number of rivets along the connecting flanges. Also, in comparison with the spot welding method, the flanging method is characterized by a shorter cycle time. Thus, by using a flanging method, especially with structural components made of light metals, for which a spot welding method is excluded, the cycle time required to produce the structural components can be substantially reduced. In addition, shell sections made of different materials can be fastened to one another. A further advantage of the flanging method lies in the extremely low susceptibility to failure of the flanging tools, especially in comparison with riveting tools.

The use of flanging methods in the production of vehicle components is already known. However, up to now the flanging method has been used only on non-weight-bearing components of the outer skin. It is most frequently used to connect reinforcing under-shells with the outer skin of the hood or the trunk lid and the doors by means of flanging. With the above-named components, the under-skin increases the inherent stability of the planar flap. It is not a task of the listed outer shell components to translate forces to an appreciable degree in the normal operation of the vehicle.

In contrast, it is proposed in accordance with the invention that with elongated structural components that perform a support function, and that especially in the event of a crash would lie in the load path, the known assembly techniques of “welding” or “riveting” be replaced with an flanging method, with the above disclosed advantages. The method of the invention therewith relates to components of the supporting structure, hence such components that contribute to the basic rigidity of the vehicle body, as distinct from the flanging method used with flaps and doors. The basic rigidity is understood to refer to the overall bending and torsion rigidity of the body of the vehicle, which are not appreciably affected by the flaps and by the doors. With the flanging of load-bearing structural components of the invention, a significant strengthening of the body is achieved, with additional advantages in terms of dynamic drive properties. For example, if the method specified in the invention is used on the front longitudinal supports of a vehicle body, then bracing of the vehicle is improved appreciably as a result of the reinforcement of the front end of the body that is achieved, especially in the form of more precise steering behavior and greater precision in all steering maneuvers. This is based upon the continuous linear connection of the component halves, which in comparison with the punctiform connection of the known rivet connections provides greater reinforcement.

It is particularly advantageous to apply a “strengthening adhesive” to at least one connecting flange prior to flanging. The strengthening adhesive increases the overall rigidity of the component, which produces an especially positive effect on the handling of the vehicle, as disclosed above. Furthermore, the strengthening adhesive prevents the flanged joint from opening up under stress that is applied perpendicular to the plane of the flange. In this manner, it is ensured that the flanged joint will be maintained over its entire length, even in the event of a crash, and the structural component can consequently reduce energy to a great degree. The adhesive also seals the joint surface against the penetration of water.

With the use of a strengthening adhesive, a method according to the invention differs further from the known flanging method used on flaps and doors, such as is known from German publication DE 199 27 207 A1. While, with flaps and doors, the adhesive is used only to seal the flanged joint, the strengthening adhesive used in accordance with the invention contributes significantly to increasing the basic rigidity of the support structure.

Suitable adhesives include primarily high-strength and shear-resistant single-component epoxy adhesives.

In comparison with the assembly technique of spot welding with the use of strengthening adhesives, flanging yields an advantage in that the adhesive does not involve any undesired introduction of heat. With spot welding, the adhesive overheats in the area around the weld nugget, resulting in a reduced effective surface for the strengthening adhesive, as well as health risks caused by the fumes that are created. In contrast, with flanging, the effective surface area of the adhesive is completely maintained. With cold flanging joining, basically no zones of influence by heat are created in the metal, so that the load-bearing capacity of the connection is increased in relation to a welding process. This produces an especially positive effect in load-bearing components that in the event of a crash are subjected to high levels of stress.

Based upon the type of adhesive used, it can be advantageous to subject the assembled structural component to heat treatment as an individual component, in other words prior to its installation in the unfinished body of the motor vehicle, in order to achieve a surface hardening of the adhesive. This heat treatment can be implemented, for example, in a furnace designed especially for this purpose, in body work (“body work furnace”). The final hardening of the adhesive follows subsequently when the unfinished body is inserted into a paint-drying furnace, where the adhesive reaches its final strength via temperature hardening. Through the previous heat treatment, the adhesive obtains a “surface skin” and can thus no longer be flushed away in the KTL [cathodic dip painting] bath. In this manner, contaminants in the KTL bath, and thus also contaminants in the unfinished body to be coated, are prevented.

A method according to the invention can be used in a particularly advantageous manner with support components that are comprised of deep-drawn shell sections. Shell sections of this type can be produced with great freedom in terms of component shape. Due to a uniform production method for the individual shell sections, the finished support component is distinguished by uniform properties. In principle, however, the method is also suited for connecting shell sections that are produced via different processes, for example the connection of a deep-drawn shell section and an extrusion component.

Special advantages result from the use of a method according to the invention in structural components made of light metals or light metal alloys, as here the especially time-consuming riveting process can be replaced with flanging.

If the flanging takes place at the end of a pressing line, then the structural component can be produced fully automatically in the press shop. Here, preferably two shell sections, which are brought into their form in preceding press stations, are provided with adhesive at an orienting station, and then assembled at the end of the pressing line to form the finished structural component, in that the tool inserted into the press connects the flanges of the shell sections to one another via flanging. In this way, the handling costs that would be incurred in bodywork because the shell sections, which are present as semi-finished products, must be inserted by hand and the finished structural component must then be removed by hand, are eliminated.

The above-described shifting of the flanging from bodywork to the press shop is particularly well suited for structural components that are approximately as simple as IHU components, so that the shell sections can be assembled in the press shop.

If, in contrast, internal fittings such as partitions or sleeves are necessary, it is more expedient for the shell sections to be attached to one another via flanging in bodywork, following insertion of the internal fittings.

Of course, the flanging can also be implemented by means of a flanging device. Due to the simple shape of the elongated structural components, a comparatively simple two or three dimensionally operating device will suffice. In the flanging of the structural components, the use of a costly robot to achieve additional degrees of freedom can as a rule be omitted.

The shell sections of support components have considerably greater material thicknesses, especially in the case of light metal materials due to the required rigidity, than is the case with non-supporting components, such as flaps and doors. It is thus proposed pursuant to the invention that the shell sections be heated locally prior to and/or during the flanging process, at least in the area of greatest deformation. In this manner, the tendency toward cracking in the highly stressed bending area on the outside of the bending radius is counteracted. Furthermore, the bending radii can be reduced, which is of decisive importance considering the great material thicknesses used, in order to achieve a sufficiently large overlapping adhesive surface with narrow space requirements.

To optimize the flanging process with sheet aluminum, the temperature in the area of greatest deformation amounts to approximately 450° C. In order that this extreme heating only takes place locally, the heat absorption must be limited to the line along the flange fold, with an expansion of only a few millimeters perpendicular to the flanged joint. By applying the smallest amount of heat possible, a strong temperature gradient relative to the surrounding environment is achieved. Furthermore, care must be taken that the necessary heat energy is applied within a short time. In the case of aluminum, for example, despite its high thermal conductivity coefficient, these measures will prevent the thermal energy from expanding up to the area of the adhesive surface. Temperatures of approximately 200° C. represent the absolute upper limit for the strengthening adhesives in question. In the area that is subjected to high temperatures, no adhesive is applied to the shell section, since the adhesive would burn here.

The heat can be applied, for example, by means of elongated infrared radiators or inductance coils. Both types of heat generating devices are characterized by low energy consumption and can be accommodated in the flanging tool, with advantages in terms of a direct application of heat. If the heat source is incorporated into the tool, then in order to prevent heating of the entire tool and to reduce the consumption of energy, an insulation of the heat source is necessary. It is also possible to cool the tool in the area of the heat source, for example by means of a cooling fluid.

The heating of the shell sections can also be accomplished outside of the tool, for example in the production of the structural component in a pressing line on an orienting station between two presses.

A further possibility is preheating at least one of the shell sections to a temperature of approximately 70 to 90° C., in order that the local heating in the area of the greatest deformation can then be implemented more rapidly. This preheating of the entire shell section can be accomplished inside or outside of the tool. If a combined cutting/shaping tool is to be used, then preheating will also reduce the formation of flakes when the aluminum is cut.

The introduction of heat preferably takes place after the flanging flange has been folded back by 90°, before the final bending by 180°. However, the temperature control of the bending area may be restricted to the first bending process (folding by 90°), or can be extended to both flanging steps.

The heating of the flanged joint not only simplifies the flanging process and keeps the material free from cracks. The amount of heat that is applied is also sufficient to effect a pre-gelling of the adhesive. In this manner, the above described separate heat treatment in a “body work furnace” to effect a surface hardening of the adhesive can be omitted, while ensuring the purity of the KTL bath.

The invention is represented in the drawings, and below will be described in greater detail.

### BRIEF DESCRIPTION OF THE DRAWINGS

FIG. 1 illustrates a perspective view of a structural component produced in accordance with the invention, with an integral representation of the cross-section of the structural component,

FIG. 2 illustrates a flanging tool into which the structural component from FIG. 1 is inserted,

FIG. 3 illustrates an enlarged, detailed view of a flange area of the structural component of FIG. 1, and

FIGS. 4a through 4c illustrate schematic cross-sections of structural components produced in accordance with the invention.

### DETAILED DESCRIPTION OF THE INVENTION

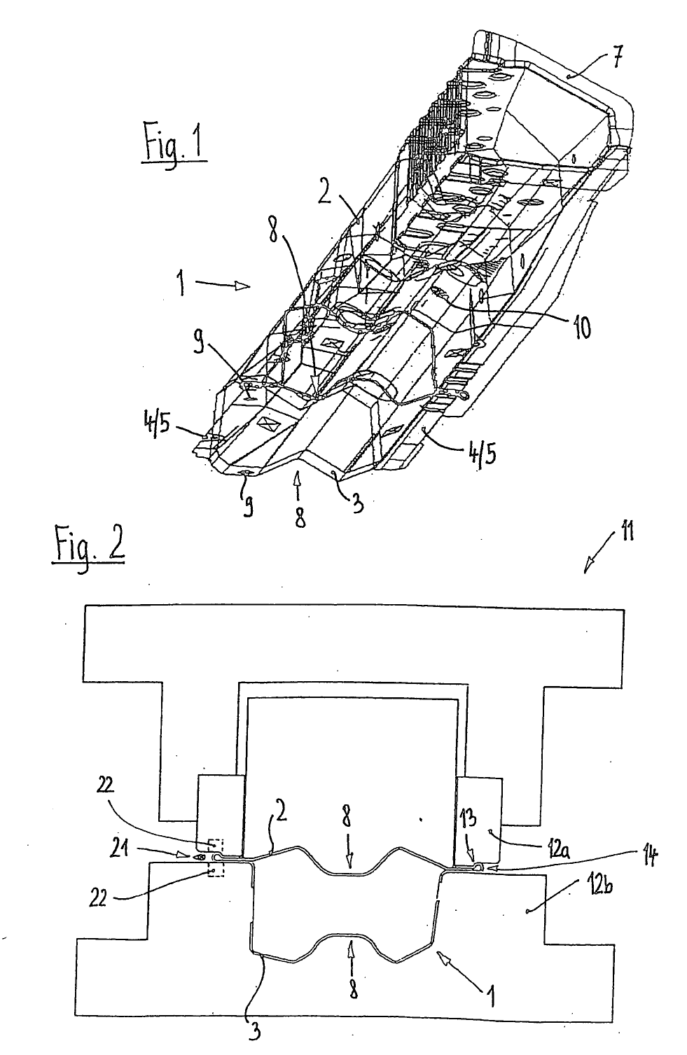

FIG. 1 shows a motor support 1, which is assembled from an upper shell section 2 and a lower shell section 3. The flanges 4 and 5 of the two shell sections 2 and 3 are attached to one another over their entire length by means of flanging. On the end segment of the motor support 1, a connecting flange 7 that extends perpendicular to its longitudinal extension is provided for the purpose of attaching the support 1 to the body of the motor vehicle. The two shell sections 2 and 3 are provided with beads 8 over a partial area of their length. The two shell sections 2 and 3 are equipped with a series of boring holes 9 and inserts 10.

FIG. 2 shows the final phase of the production of a structural component 1 as represented in FIG. 1, in an example of tools 12a, 12b inserted into a press 11. Here the flange 5 of the shell section 3 is bent around the flange 4 of the shell section 2 by means of the upper tool 12a. A radius 13 is provided here on the tool 12b that generates a so-called hollow flange 14.

FIG. 3 shows a closer view of the area in which the flanges 4 and 5 are connected. On the contact surfaces between the flanges 4 and 5, adhesive 23 is applied, which when the two flanges 4 and 5 are pressed together fills up the gap that remains between the flanges 4 and 5, and after it has hardened binds the flanges 4 and 5 flat against one another. The adhesive 23 serves to prevent a separation of the flanged joint.

The flanging process is designed such that by means of the so-called “popping open” (hence reshaping following completion of the flanging process), a gap of 0.3 mm at the most, ideally 0.1 to 0.2 mm at the most, is created in the area of the contact surfaces between the flanges 4 and 5, which can be bridged by the adhesive 23. As the adhesive 23, “BETAMATE 1496” from the firm Gurrit-Essex AG may be used, for example.

Preferably, the exterior of the hollow flange 14, designated by the number 19, is heated by a heat source 21, schematically represented in FIGS. 2 and 3, before the represented bending by 180° is implemented. In this manner, damage to the area 19 on the outside and to an area 20 on the inside of the hollow flange 14, in other words at the point where in the deformation process the greatest stress from tension and/or pressure occurs, is counteracted. Furthermore, the heating can cause the radius of the hollow flange 14 to be reduced, with advantages in terms of component space and/or the size of the adhesive surface.

As an alternative to positioning the heat source 21 outside of the tools 12a and 12b, the heat source can also be positioned in a recess 22 in one or in both tools 12a and/or 12b, as is indicated in FIG. 2 by dashed lines.

The heat source 21, in keeping with the longitudinal extension of the structural component 1, likewise has an elongated form and is positioned immediately adjacent to the flanges 4 and 5 for the purpose of direct heating to be restricted to the areas 19 and 20.

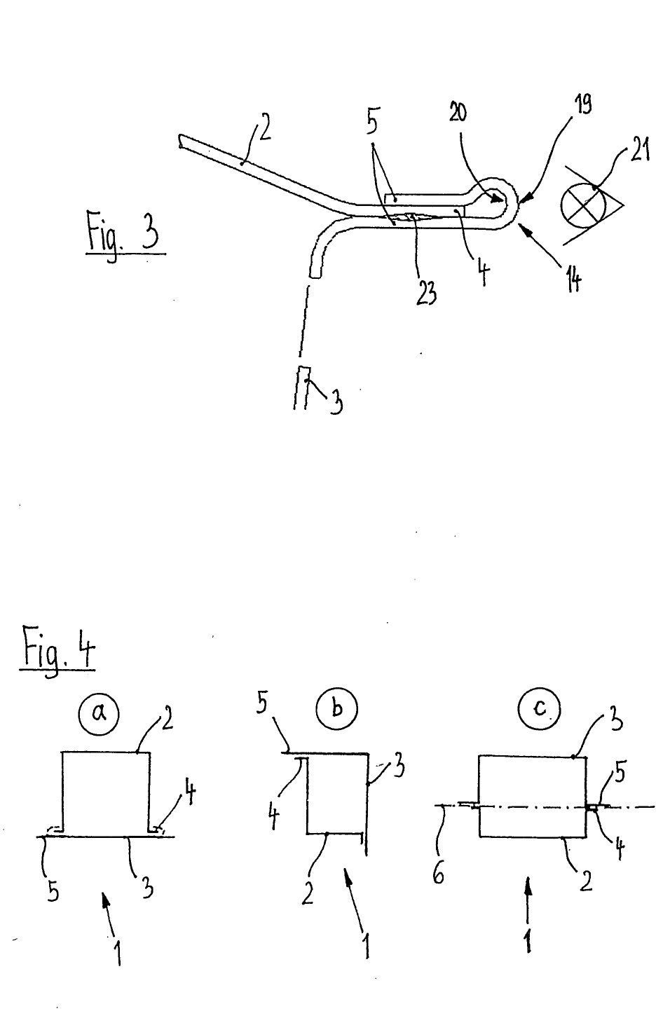

FIGS. 4a through 4c show, by way of example, possibilities for the basic construction of elongated structural components 1, each of which is comprised of two shell sections 2 and 3.

According to FIG. 4a, the structural component 1 is comprised of a first shell section 2 that is essentially U-shaped in its cross-section, with projecting attachment flanges 4, and which is complemented by a second shell section 3 that is designed as a closing panel to form a closed hollow profile. The lateral end sections of the shell section 3 at the same time form the connecting flanges 5, which in the preceding example in their initial state extend beyond the flanges 4 and—as is represented by a dotted line—are bent around in the flanging process such that they cover the upper sides of the flanges 4.

According to FIG. 4b, the two shell sections 2 and 3 can also be L-shaped in design, with flanges 4 and 5 at the ends of the shell sections 4 and 5, respectively.

With structural components 1 pursuant to FIG. 4c, which are comprised of two U-shaped shell sections 2 and 3, the separating plane 6 in a vertical direction, based upon the orientation of the structural component 1, can be laid out such that the flanges 4 and 5 form mounting surfaces in the joint plane 6 for other components, such as the floor of a trunk.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A method for producing a structural component for a motor vehicle, including at least two shell sections that are attached to one another along flanges, comprising attaching the shell sections of the structural component to one another by flanging.

2. The method according to claim 1, further comprising applying an adhesive, which is very strong and highly rigid after hardening, to at least one of said flanges prior to the flanging.

3. The method according to claim 2, wherein a single-component epoxy adhesive is used as the adhesive.

4. The method according to claim 1, wherein at least one of the shell sections is produced by a deep-draw process.

5. The method according to claim 1, wherein at least one of the shell sections is made of a light metal alloy.

6. The method according to claim 2, wherein the flanging takes place in a final station of a pressing line, following production of the shell sections.

7. The method according to claim 6, wherein the adhesive is applied automatically to the flanges at an orienting station prior to the final station.

8. The method according to claim 1, further comprising heating at least one of the shell sections prior to the flanging.

9. The method according to claim 8, wherein the heating is restricted locally to a linear area that undergoes a greatest deformation as a result of the flanging.

10. The method according to claim 8, wherein a heat-generating device positioned outside of a tool or a flanging device is provided for the heating.

11. The method according to claim 8, wherein a heat-generating device positioned in a recess of a tool is provided for the heating.

12. The method according to claim 1, wherein said structural component is an elongated support component.

13. The method according to claim 6, wherein the flanging takes place immediately following the production of the shell sections.

14. The method according to claim 2, wherein at least one of the shell sections is produced by a deep-draw process.

15. The method according to claim 3, wherein at least one of the shell sections is produced by a deep-draw process.

16. The method according to claim 2, wherein at least one of the shell sections is made of a light metal alloy.

17. The method according to claim 3, wherein at least one of the shell sections is made of a light metal alloy.

18. The method according to claim 4, wherein at least one of the shell sections is made of a light metal alloy.

19. The method according to claim 1, wherein the flanging takes place in a final station of a pressing line, following production of the shell sections.

20. The method according to claim 3, wherein the flanging takes place in a final station of a pressing line, following production of the shell sections.

21. The method according to claim 20, wherein the adhesive is applied automatically to the flanges at an orienting station prior to the final station.

22. The method according to claim 4, wherein the flanging takes place in a final station of a pressing line, following production of the shell sections.

23. The method according to claim 5, wherein the flanging takes place in a final station of a pressing line, following production of the shell sections.

24. The method according to claim 1, further comprising heating at least one of the shell sections during the flanging.

25. The method according to claim 24, wherein the heating is restricted locally to a linear area that undergoes a greatest deformation as a result of the flanging.

26. The method according to claim 24, wherein a heat-generating device positioned outside of a tool or a flanging device is provided for the heating.

27. The method according to claim 24, wherein a heat-generating device positioned in a recess of a tool is provided for the heating.

28. The method according to claim 9, wherein a heat-generating device positioned outside of a tool or a flanging device is provided for the heating.

29. The method according to claim 9, wherein a heat-generating device positioned in a recess of a tool is provided for the heating.

30. The method according to claim 1, further comprising heating at least one of the shell sections prior to and during the flanging.

31. A structural component for a motor vehicle, including at least two shell sections that are attached to one another along flanges, produced by the method of claim 1.
